(19) United States
(12) Patent Application Publication
(10) Pub. No.: US 2006/0107787 A1
(43) Pub. Date: May 25, 2006

(54) Adjustable gear position arrangement for synchronization of multiple generators

(75) Inventors: Christopher J. Herlihy, Scottsdale, AZ (US); Ronald P. Maty, Chandler, AZ (US); Edward M. Brady, Scottsdale, AZ (US)

Correspondence Address: Honeywell International, Inc.;Law Dept AB2, P.O. Box 2245, Morristown, NJ, 07962-9806, US

(73) Assignee: Honeywell International Inc., Morristown, NJ (US)

(21) Appl. No.: 10/994,900

(22) Filed: Nov. 22, 2004

(51) Int. Cl. F16H 48/12

(52) U.S. Cl. 74/650

(57) ABSTRACT

An adjustable gear arrangement for synchronization of multiple generators in a gas turbine engine is provided. The adjustable gear arrangement comprises a two-piece splined shaft that allows for the precise adjustment of the gears in synchronizing the generators. A method for synchronizing multiple generators using the adjustable gear arrangement of the present invention is also provided.

### BACKGROUND OF THE INVENTION

This invention generally relates to gear arrangements for synchronization of multiple generators and more specifically to adjustable gear arrangements having a two-splined shaft and a helical gear for coarse and fine adjustments for synchronizing the drive shafts of multiple generators.

Engines having multiple, gearbox-mounted generators often require the generator drive gears in the gearbox to be phased to the generator rotor position for efficient delivery of generated power. The multiple generators are driven through a series of gears that allow increasing engine output speed to the necessary generator input speed. Each individual generator stator has to be in precisely the same position relative to its rotor as all the other generators. This requires all the gears in the drive train to be synchronized as well since they are attached to the generators.

Most of the gear arrangements and methods of synchronization of multiple drive shafts of the prior art require synchronization of the drive shafts during actual operation of the engine. This can be time consuming and difficult, especially when more than two rotating shafts are involved. For example, U.S. Pat. Nos. 3,939,723 and 4,207,815 describe a gear arrangement utilizing the relative axial position of helical gears to adjust relative circumferential position of two rotating shafts during operation of a motor. Neither gear arrangement from either patent allows for synchronization of the rotating shafts prior to engine operation, nor do they allow for synchronization of more than two rotating shafts.

As can be seen, there is a need for a gear arrangement that allows for synchronization of rotating drive shafts prior to engine operation, particularly during manufacture of the engine. There is also a need for a gear arrangement that allows for the synchronization of multiple drive shafts, particularly greater than two drive shafts, without requiring precision manufacturing of gear teeth elements relative to generator driveshaft splines.

### SUMMARY OF THE INVENTION

In one aspect of the invention there is provided an adjustable gear arrangement comprising a two-piece splined shaft, the two-piece splined shaft comprising an intermediate shaft comprising an internal spline; a drive gear shaft comprising a generator drive gear; a fine pitch spline comprising external spline teeth on the intermediate shaft and internal spline teeth on the drive gear shaft, the fine pitch spline connecting the intermediate shaft and the drive gear shaft; and a generator drive shaft, the generator drive shaft connected to the intermediate shaft through the internal spline;

In another aspect of the invention there is provided an adjustable gear arrangement comprising a two-piece splined shaft comprising an intermediate shaft comprising an internal spline; a drive gear shaft comprising a generator drive gear; a fine pitch spline comprising external spline teeth on the intermediate shaft and internal spline teeth on the drive gear shaft, the fine pitch spline connecting the intermediate shaft and the drive gear shaft; a generator drive shaft, the generator drive shaft connected to the intermediate shaft through the internal spline; an idler gear, the idler gear engaging the generator drive gear; an input gear, the input gear engaging the idler gear; and an engine quill shaft, the engine quill shaft driving the input gear.

In a further aspect of the present invention there is provided an adjustable gear arrangement comprising a two-piece splined shaft, the two-piece splined shaft comprising an intermediate shaft comprising an internal spline; a drive gear shaft comprising a generator drive gear, wherein the generator gear drive comprises drive gear teeth; a fine pitch spline comprising external spline teeth on the intermediate shaft and internal spline teeth on the drive gear shaft, the fine pitch spline connecting the intermediate shaft and the drive gear shaft, wherein the fine pitch spline has from about 1 to about 20 more external spline teeth and from about 1 to about 20 more internal spline teeth than the generator drive gear has drive gear teeth; a generator drive shaft, the generator drive shaft connected to the intermediate shaft through the internal spline; an idler gear, the idler gear engaging the generator drive gear, wherein the idler gear comprises idler gear teeth and wherein the number of drive gear teeth of the generator drive gear is divisible by a first prime number and the number of idler gear teeth of the idler gear are divisible by a second prime number; an input gear, the input gear engaging the idler gear; and an engine quill shaft, the engine quill shaft driving the input gear.

In yet another aspect of the present invention there is provided a gearbox comprising an adjustable gear arrangement, the adjustable gear arrangement comprising a two-piece splined shaft, the two-piece splined shaft comprising an intermediate shaft comprising an internal spline; a drive gear shaft comprising a generator drive gear; a fine pitch spline comprising external spline teeth on the intermediate shaft and internal spline teeth on the drive gear shaft, the fine pitch spline connecting the intermediate shaft and the drive gear shaft; a generator drive shaft, the generator drive shaft connected to the intermediate shaft through the internal spline; an idler gear, the idler gear engaging the generator drive gear; an input gear, the input gear engaging the idler gear; and an engine quill shaft, the engine quill shaft driving the input gear.

In another aspect of the present invention there is provided a gas turbine engine, wherein the gas turbine engine is coupled to a gearbox, the gearbox comprising a gearbox, the gearbox comprising at least two adjustable gear arrangements, the gear arrangements each comprising a two-piece splined shaft, the two-piece splined shaft comprising an intermediate shaft comprising an internal spline; a drive gear shaft comprising a generator drive gear; a fine pitch spline comprising external spline teeth on the intermediate shaft and internal spline teeth on the drive gear shaft, the fine pitch spline connecting the intermediate shaft and the drive gear shaft; and a generator drive shaft, the generator drive shaft connected to the intermediate shaft through the internal spline; an idler gear, the idler gear engaging the generator drive gear, an input gear, the input gear engaging the idler gear, and an engine quill shaft, the engine quill shaft driving the input gear; and at least two gearbox-mounted generators, wherein the gearbox-mounted generators are connected to the gearbox through the generator drive shaft.

In yet another aspect of the invention there is provided a method for synchronization of multiple generators in a gas turbine engine comprising the steps of locking an input gear and an idler gear, wherein the input gear engages the idler gear; rotating a drive gear shaft, the drive gear shaft comprising a helical generator drive gear and a fine pitch spline, wherein the generator drive gear is engaged by the idler gear; positioning the drive gear shaft to a desired degree of alignment with an intermediate shaft, wherein the intermediate shaft is connected to the drive gear shaft through the fine pitch spline; advancing the helical generator drive gear axially by varying a thickness of a shim to fine tune the degree of alignment ; clamping the generator drive gear in position; and repeating all of the above steps above for each generator to be synchronized.

These and other features, aspects and advantages of the present invention will become better understood with reference to the following drawings, description and claims.

### BRIEF DESCRIPTION OF THE DRAWINGS

FIG. 1 is a cross-sectional view of a turbine engine according to the invention;

FIG. 2 is a partial cross-sectional view of a turbine engine gearbox showing an adjustable gear arrangement according to the present invention;

FIG. 3 is an expanded view of a portion of FIG. 2;

FIG. 4 is an end view of the adjustable gear arrangement of FIG. 2; and

FIG. 5 is a flow chart for a method of synchronization of multiple generators.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, an adjustable gear arrangement is provided by the present invention for the synchronization of multiple generators driven by a gas turbine engine. According to the application, some gas turbine engines may have multiple generators which may be mounted on a single gearbox. For efficient power generation, it may be desirable to synchronize the generators such that they are driven in a precise parallel manner. The adjustable gear arrangement of the present invention may allow for the precise synchronization of the generators so that they may be driven in a precisely parallel manner. The adjustable gear arrangement may be used, for example, in combination with any gas turbine engine having multiple gearbox-mounted generators, such as the engines used in gas turbine-driven land vehicles.

Currently in the prior art, the synchronization of multiple generators in gas turbine engines and other applications may be accomplished by adjusting the relative axial position of a helical gear. This adjustment may have to be done after the engine is assembled and while the engine is running, which may be awkward and time consuming. Additionally, precise synchronization may require precision manufacturing of the helical gears and other engine parts. The greater the number of multiple generators, the more difficult it may be to precisely synchronize the generators. The adjustable gear arrangement of the present invention may eliminate these deficiencies as it may allow for two-step synchronization of multiple generators with a fine-tuning step after the initial synchronization. The present invention may provide precise synchronization for multiple generators with a greater number of multiple generators, i.e., greater than two generators using a two-piece splined shaft as well as the axial adjustment of a helical gear. The adjustment of a two-piece splined shaft in combination with the axial adjustment of a helical gear may allow for more precise synchronization than the axial adjustment of a helical gear alone. Furthermore, the present invention may allow for the precise synchronization of multiple generators at assembly without incorporating excessive precision manufacturing requirements.

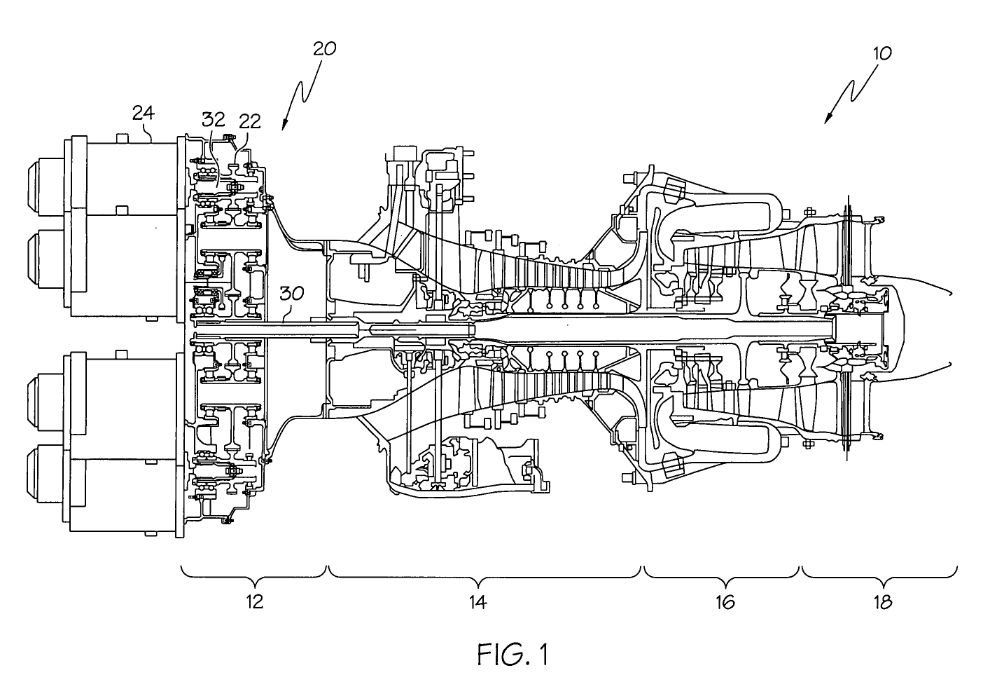

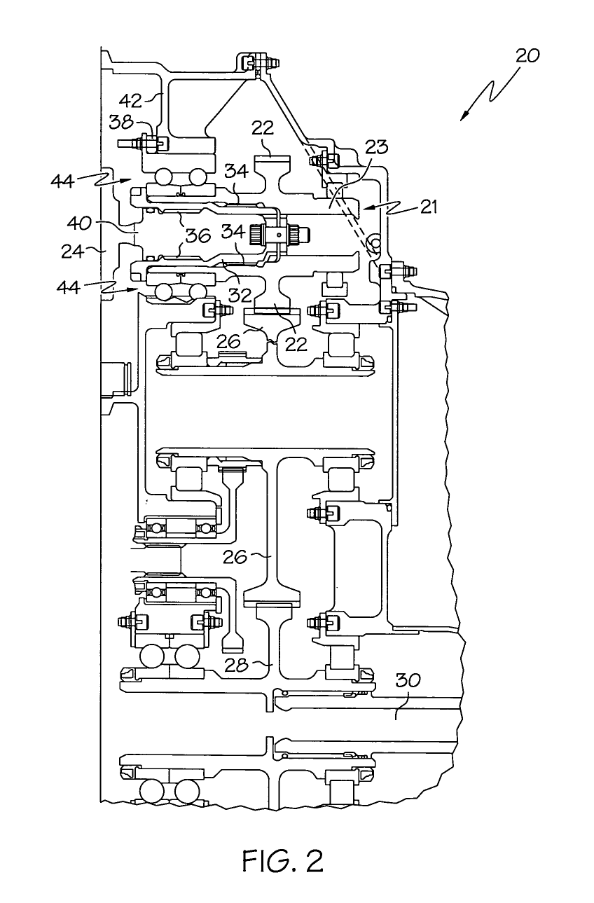

Illustrated in FIG. 1 is a cross-section of a gas turbine engine 10 where the gas turbine engine 10 may be coupled to multiple generators 24. Gas turbine engine 10 may be coupled to at least two generators 24, wherein all of generators 24 may be mounted on a single gearbox 12. Although the gas turbine engine 10 illustrated in FIG. 1 shows four gearbox-mounted generators 24, it is contemplated that gas turbine engine 10 may have any number of gearbox-mounted generators 24. In an illustrative embodiment, gas turbine engine 10 may have six gearbox-mounted generators 24. Gas turbine engine 10 may further comprise a gas generator 14, a combustor module 16, and a turbine module 18 which are connected to the generator 24 through an engine quill shaft 30 in gearbox 12. When gas turbine engine 10 is in operation, quill shaft 30 drives generator 24 through a set of gears (see, for example, FIG. 2).

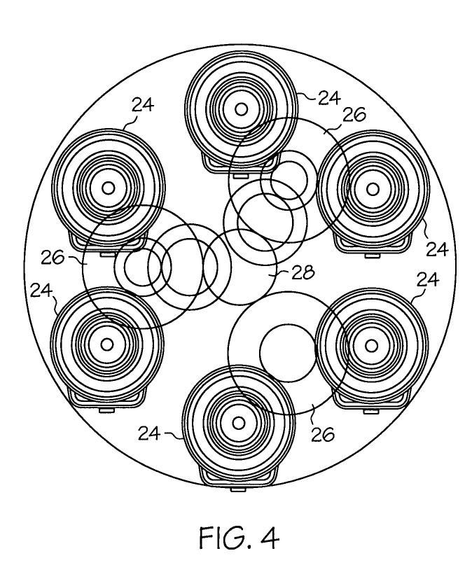

Referring to FIGS. 2, 3 and 4, an adjustable gear arrangement 20 for synchronization of multiple generators 24 may comprise a two-piece splined shaft 21 for driving generator 24; two-piece splined shaft 21 may comprise a drive gear shaft 23 and an intermediate shaft 32. Drive gear shaft 23 and intermediate shaft 32 may be coupled through a fine pitch spline 34. Fine pitch spline 34 may comprise external spline teeth (not shown) on intermediate shaft 32 and internal spline teeth (not shown) on drive gear shaft 23, enabling drive gear shaft 23 and intermediate shaft 32 to rotate together. Drive gear shaft 23 may further comprise a generator drive gear 22 which connects engine quill shaft 30 to the two-piece splined shaft 21. Intermediate shaft 32 may further comprise internal spline 36 which may couple intermediate shaft 32 with the external spline (not shown) of a generator drive shaft 40, where generator drive shaft 40 may be connected to generator 24. The external spline of generator drive shaft 40 may incorporate a timing feature such as a missing tooth which may engage an extra tooth on the internal spline 36. Adjustable gear arrangement 20 may also comprise idler gear 26 and input gear 28, wherein input gear 28 may engage idler gear 26, and idler gear 26 may then engage generator drive gear 22. In one illustrative embodiment, generator drive gear 22, idler gear 26 and input gear 28 may be helical gears.

Two-piece splined shaft 21 may allow for greater precision in synchronization of multiple generators 24 compared to synchronization by alignment of generator drive gear 22 alone. Two-piece splined shaft 21 may comprise drive gear shaft 23, where drive gear shaft 23 may comprise fine pitch spline 34. Fine pitch spline 34 may comprise a large number of external spline teeth (not shown) on intermediate shaft 32 and a large number of internal spline teeth (not shown) on drive gear shaft 23, enabling drive gear shaft 23 and intermediate shaft 32 to rotate together. By way of non-limiting example, fine pitch spline 34 may have from about 50 to about 70 each external and internal spline teeth. As the total number of spline teeth increases, the synchronization of multiple generators 24 may become more precise. Fine pitch spline 34 may be adjusted with respect to intermediate shaft 32 in synchronizing multiple generators 24 and the greater the number of spline teeth, the more precise the adjustment. If a single, one-piece shaft was used instead of the two-piece splined shaft 21, then this level of precise adjustment may not be available. The number of spline teeth of fine pitch spline 34 may only be limited by the size of fine pitch spline 34, the size of which may be determined by the size of gas turbine engine 10.

Drive gear shaft 23 may further comprise generator drive gear 22. The degree of synchronization of multiple generators 24 achievable by the present invention may be a function of the number of drive gear teeth of generator drive gear 22 and the number of spline teeth of fine pitch spline 34. The greater the numbers of drive gear teeth on generator drive gear 22 or spline teeth of fine pitch spline 34, the smaller the increments that either generator drive gear 22 or fine pitch spline 34 may be moved to synchronize multiple generators 24. It will be appreciated that the smaller the increments of movement, the more precise the synchronization of generators 24 may be. In one illustrative embodiment, generator drive gear 22 and fine pitch spline 34 may each have from about 50 to about 75 drive gear teeth and external and internal spline teeth, respectively. As discussed above for fine pitch spline 34, the number of drive gear teeth on generator drive gear 22 may be limited by the size of generator drive gear 22. In one embodiment, fine pitch spline 34 may have more spline teeth than generator drive gear 22 has drive gear teeth. For example, fine pitch spline 34 may have from about 1 to about 20 more external spline teeth and from about 1 to about 20 more internal spline teeth than generator drive gear 22 has drive gear teeth. Alternatively, fine pitch spline 34 may have from about 2 to about 5 more external spline teeth and from about 2 to about 5 more internal spline teeth than generator drive gear 22 has drive gear teeth. In an illustrative embodiment, fine pitch spline 34 may have about 61 each external spline teeth and internal spline teeth, while generator drive gear 22 may have about 59 drive gear teeth. By way of non-limiting example where fine pitch spline 34 has 61 each external and internal spline teeth and generator drive gear 22 has 59 teeth, rotating drive gear shaft 23 with respect to intermediate shaft 32 by one spline tooth may result in an angle change of 5.90°. Rotating drive gear shaft 23 may also cause generator drive gear 22 to rotate one by one drive gear tooth with respect to idler gear 26 which may result in a second angle change of 6.10°. The difference between the two angle changes, 0.2°, may be the angle change for internal spline 36 of intermediate shaft 32 with respect to generator drive shaft 40. This small change in the angle for internal spline 36 allows for precise synchronization of multiple generators 24.

The generator speed may be established by the combination of the number of drive gear teeth on the generator drive gear 22 and idler gear teeth on the idler gear 26. In one embodiment, the number of drive gear teeth of generator drive gear 22 is divisible by a first prime number and the number of idler gear teeth of idler gear 26 is divided by a second prime number, wherein the first prime number and the second prime number are different. In the most basic example, the number of drive gear teeth of generator drive gear 22 may be a first prime number and the number of idler gear teeth of idler gear 26 may be a second prime number, where the first prime number and the second prime number are different.

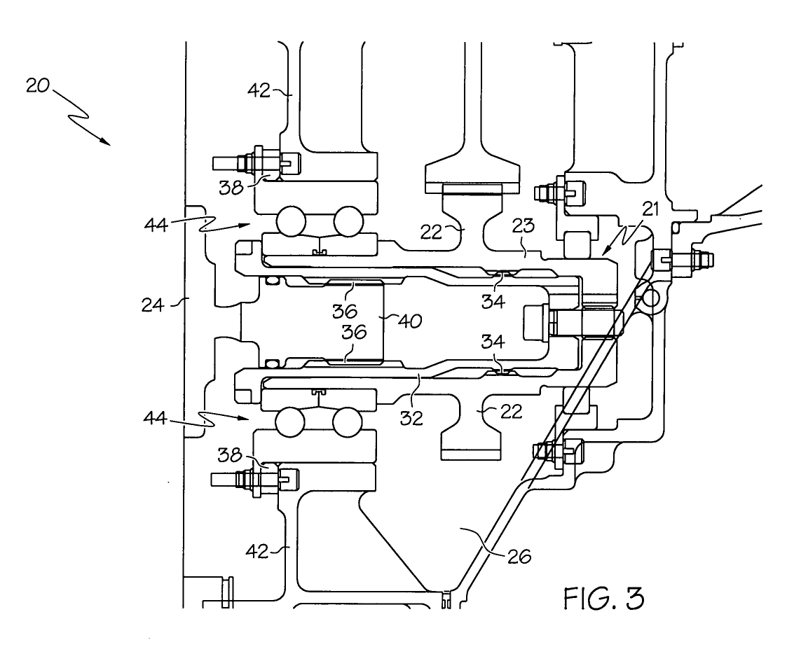

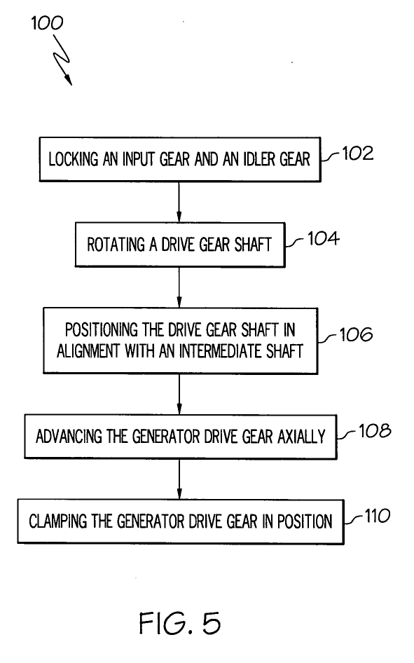

Adjustable gear arrangement 20 may further comprise a shim 38 located under gear mounting flange 42 and connecting to drive gear shaft 23 through a thrust bearing assembly 44. Varying the thickness of shim 38 may control the axial position of generator drive gear 22 (see, for example, FIG. 5, step 108). By way of non-limiting example, thrust bearing assembly 44 is shown in FIGS. 2 and 3 as a duplex bearing assembly. However, thrust bearing assembly 44 may be of any design, such as but not limited to, single-row, double-row or duplex design.

It is contemplated that adjustable gear arrangement of the present invention may be used in any application requiring the accurate synchronization of multiple shafts driven through a gear system, including, but not limited to the synchronization of multiple generators of a gas turbine engine.

FIG. 5 illustrates a method 100 for synchronization of multiple generators of a gas turbine engine using the adjustable gear arrangement of the present invention. Step 102 may be to lock an input gear and an idler gear. The input gear may engage the idler gear and by locking both gears, they may not rotate during the adjustment of the remainder of gears in the adjustable gear arrangement. Step 104 may be to rotate a drive gear shaft wherein the drive gear shaft may be rotated in either direction. The drive gear shaft may comprise a fine pitch spline and a generator drive gear which may rotate together when the drive shaft is rotated. In Step 106, the drive shaft may be positioned in alignment to the intermediate shaft. The achievable alignment in step 106 may be a function of the products of the number of teeth of the generator drive gear, the idler gear and the fine pitch spline. Step 108 may be to advance the generator drive gear axially. The axial positioning of the generator drive gear may be controlled by varying the thickness of a shim located under the gear mounting flange. Since the generator drive gear may be held against the locked idler gear while being axially advanced, drive gear teeth of the generator drive gear cause rotation of the generator drive gear relative to the locked idler and input gears in small increments. Adjusting the axial position of the gear drive shaft and consequently, the generator drive gear, is a ‘fine tune’ adjustment of the synchronization. Finally, Step 110 may be to clamp the generator drive gear into position. Method 100 of synchronization of multiple generators may be repeated for all of the generators until the degree of alignment of all the generators are within the desired tolerance. In an illustrative embodiment, the degree of alignment for all the generators may differ by from about ±0.1° to about ±1.0° with respect to a rotor and stator of each generator. Although the foregoing method is described for synchronizing multiple generators is a gas turbine engine, it is contemplated that the method may be used in any application requiring the accurate synchronization of multiple shafts driven through a gear system.

It should be understood, of course, that the foregoing relates to exemplary embodiments of the invention and that modifications may be made without departing from the spirit and scope of the invention as set forth in the following claims.

We claim:

1. An adjustable gear arrangement comprising:
a two-piece splined shaft, the two-piece splined shaft comprising;
an intermediate shaft comprising an internal spline;
a drive gear shaft comprising a generator drive gear;
a fine pitch spline comprising external spline teeth on the intermediate shaft and internal spline teeth on the drive gear shaft, the fine pitch spline connecting the intermediate shaft and the drive gear shaft; and
a generator drive shaft, the generator drive shaft connected to the intermediate shaft through the internal spline.

2. The adjustable gear arrangement of claim 1 wherein the generator drive gear comprises drive gear teeth.

3. The adjustable gear arrangement of claim 2 wherein the generator drive gear comprises from about 50 to about 75 drive gear teeth and the fine pitch spline comprises from about 50 to about 75 external spline teeth and from about 50 to about 75 internal spline teeth.

4. The adjustable gear arrangement of claim 2 wherein the fine pitch spline has from about 1 to about 20 more external spline teeth and from about 1 to about 20 more internal spline teeth than the generator drive gear has drive gear teeth.

5. The adjustable gear arrangement of claim 2 wherein the fine pitch spline has from about 2 to about 5 more external spline teeth and from about 2 to about 5 more internal spline teeth than the generator drive gear has drive gear teeth.

6. The adjustable gear arrangement of claim 2 wherein the fine pitch spline has about 61 external spline teeth and about 61 internal spline teeth and the generator drive gear has about 59 gear teeth.

7. The adjustable gear arrangement of claim 1 wherein the generator drive gear is a helical gear.

8. The adjustable gear arrangement of claim 1 further comprising:
an idler gear, the idler gear engaging the generator drive gear;
an input gear, the input gear engaging the idler gear; and
an engine quill shaft, the engine quill shaft driving the input gear.

9. An adjustable gear arrangement comprising:
a two-piece splined shaft comprising;
an intermediate shaft comprising an internal spline;
a drive gear shaft comprising a generator drive gear;
a fine pitch spline comprising external spline teeth on the intermediate shaft and internal spline teeth on the drive gear shaft, the fine pitch spline connecting the intermediate shaft and the drive gear shaft;
a generator drive shaft, the generator drive shaft connected to the intermediate shaft through the internal spline;
an idler gear, the idler gear engaging the generator drive gear;
an input gear, the input gear engaging the idler gear; and
an engine quill shaft, the engine quill shaft driving the input gear.

10. The adjustable gear arrangement of claim 9 wherein the generator drive gear comprises drive gear teeth and the idler gear comprises idler gear teeth.

11. The adjustable gear arrangement of claim 10 wherein the number of drive gear teeth of the generator drive gear is a first prime number and wherein the number of idler gear teeth of the idler gear is a second prime number, wherein the first and second prime numbers are different.

12. The adjustable gear arrangement of claim 10 wherein the number of gear teeth of the generator drive gear is divisible by a first prime number and the number of gear teeth of the idler gear is divisible by a second prime number, wherein the first and second prime numbers are different.

13. The adjustable gear arrangement of claim 10 wherein the generator drive gear has from about 50 to about 75 gear teeth.

14. The adjustable gear arrangement of claim 9, wherein the adjustable gear arrangement is part of a gearbox.

15. The adjustable gear arrangement of claim 14 wherein the gearbox is coupled to a gas turbine engine.

16. An adjustable gear arrangement comprising:
a two-piece splined shaft, the two-piece splined shaft comprising;
an intermediate shaft comprising an internal spline;
a drive gear shaft comprising a generator drive gear, wherein the generator drive gear comprises drive gear teeth;
a fine pitch spline comprising external spline teeth on the intermediate shaft and internal spline teeth on the drive gear shaft, the fine pitch spline connecting the intermediate shaft and the drive gear shaft and wherein the fine pitch spline has from about 1 to about 20 more external spline teeth and from about 1 to about 20 more internal spline teeth than the generator drive gear has drive gear teeth; and
a generator drive shaft, the generator drive shaft connected to the intermediate shaft through the internal spline;
an idler gear, the idler gear engaging the generator drive gear, wherein the idler gear comprises idler gear teeth and wherein the number of drive gear teeth of the generator drive gear is divisible by a first prime number and the number of idler gear teeth of the idler gear is divisible by a second prime number, wherein the first and second prime numbers are different;
an input gear, the input gear engaging the idler gear; and
an engine quill shaft, the engine quill shaft driving the input gear.

17. The adjustable gear arrangement of claim 16 further comprising a shim, wherein the shim is disposed under a gear mounting flange and connecting to the drive gear shaft through a thrust bearing assembly.

18. The adjustable gear arrangement of claim 16 wherein the number of drive gear teeth of the generator drive gear is a first prime number and wherein the number of idler gear teeth of the idler gear is a second prime number, wherein the first prime number and the second prime number are different.

19. The adjustable gear arrangement of claim 16 wherein the generator drive gear has from about 50 to about 75 drive gear teeth.

20. The adjustable gear arrangement of claim 16 wherein the generator drive gear, the idler gear and the input gear are helical gears.

21. The adjustable gear arrangement of claim 16 wherein the thrust bearing assembly may be a single-row, double-row or duplex bearing assembly.

22. A gearbox comprising an adjustable gear arrangement, the adjustable gear arrangement comprising:
a two-piece splined shaft, the two-piece splined shaft comprising:
an intermediate shaft comprising an internal spline;
a drive gear shaft comprising a generator drive gear;
a fine pitch spline comprising external spline teeth on the intermediate shaft and internal spline teeth on the drive gear shaft, the fine pitch spline connecting the intermediate shaft and the drive gear shaft;
a generator drive shaft, the generator drive shaft connected to the intermediate shaft through the internal spine;
an idler gear, the idler gear engaging the generator drive gear;
an input gear, the input gear engaging the idler gear; and
an engine quill shaft, the engine quill shaft driving the input gear.

23. The gearbox of claim 22 wherein the generator drive gear comprises drive gear teeth and wherein the fine pitch spline has from about 1 to about 20 more external spline teeth and from about 1 to about 20 more internal spline teeth than the generator drive gear has drive gear teeth.

24. The gearbox of claim 22 wherein the generator drive gear comprises drive gear teeth and the idler gear comprises idler gear teeth and the number of drive gear teeth is divisible by a first prime number and the number of idler gear teeth is divisible by a second prime number, wherein the first and prime numbers are different.

25. The gearbox of claim 22 wherein the gearbox is coupled to a gas turbine engine.

26. The gearbox of claim 22 wherein the gearbox contains at least two of the adjustable gear arrangements.

27. The gearbox of claim 22 wherein the gearbox contains six of the adjustable gear arrangements.

28. A gas turbine engine, wherein the gas turbine engine is coupled to a gearbox, the gearbox comprising:
at least two adjustable gear arrangements, the gear arrangements each comprising:
a two-piece splined shaft, the two piece splined shaft comprising an intermediate shaft comprising an internal spline, a drive gear shaft comprising a generator drive gear and a fine pitch spline comprising external spline teeth on the intermediate shaft and internal spline teeth on the drive gear shaft, the fine pitch spline connecting the intermediate shaft and the drive gear shaft;
a generator drive shaft, the generator drive shaft connected to the intermediate shaft through the internal spline;
an idler gear engaging the generator drive gear,
an input gear engaging the idler gear, and
an engine quill shaft driving the input gear; and
at least two gearbox-mounted generators, wherein the gearbox-mounted generators are connected to the gearbox through the generator drive shaft.

29. The gas turbine engine of claim 28 wherein the number of adjustable gear arrangements is the same as the number of gearbox-mounted generators.

30. The gas turbine engine of claim 28 wherein the gas turbine engine comprises six adjustable gear arrangements and six gearbox-mounted generators.

31. A method for synchronization of multiple generators in a gas turbine engine comprising the steps of:
locking an input gear and an idler gear, wherein the input gear engages the idler gear;
rotating a drive gear shaft, the drive gear shaft comprising a helical generator drive gear and a fine pitch spline, wherein the generator drive gear is engaged by the idler gear;
positioning the drive gear shaft to a desired degree of alignment with an intermediate shaft, wherein the intermediate shaft is connected to the drive gear shaft through the fine pitch spline;
advancing the helical generator drive gear axially by varying a thickness of a shim to fine tune the degree of alignment;
clamping the generator drive gear in position; and
repeating all the steps above for each generator to be synchronized.

32. The method of claim 31 wherein the degree of alignment for each of the multiple generators differs by only from about ±0.1° to about ±1.0° from the degree of alignment of the other multiple generators.

33. The method of claim 31 wherein the generators are part of a gas turbine engine.

34. The method of claim 33 wherein the generators are synchronized during assembly of the gas turbine engine.

35. The method of claim 31 wherein at least two generators are synchronized.

36. The method of claim 31 wherein six generators are synchronized.
